(19) United States
(12) Patent Application Publication
(10) Pub. No.: US 2008/0127804 A1
(43) Pub. Date: Jun. 5, 2008

(54) Composite High Tension Drum Shell and Banjo Rim

(76) Inventors: Paul H. Lashbrook, South Bend, IN (US); Elson B. Fish, Lakeville, IN (US)

Correspondence Address: BARNES & THORNBURG LLP, P.O. BOX 2786, CHICAGO, IL, 60690-2786, US

(21) Appl. No.: 11/847,867

(22) Filed: Aug. 30, 2007

Related U.S. Application Data
(63) Continuation-in-part of application No. 11/566,535, filed on Dec. 4, 2006, now Pat. No. 7,278,788.

(51) Int. Cl. G10D 13/02

(52) U.S. Cl. 84/411 R

(57) ABSTRACT

A composite drum having a composite drum shell and a high tension drum head at a first end and a low tension drum head at a second end.

This application is a continuation-in-part application to U.S. application Ser. No. 11/566,535, filed Dec. 4, 2006, which is expressly incorporated by reference herein.

### BACKGROUND

The present disclosure relates to drums and banjos, and particularly to drum shells and banjo rims. More particularly, the present disclosure relates to a composite high tension drum shell and banjo rim.

### SUMMARY

According to the present disclosure, a drum includes a drum shell and first and second drum heads positioned on opposite ends of the drum shell.

In illustrative embodiments, the drum shell and banjo rim are comprised of a resin matrix with fumed silica therein and a substantially continuous filament material helically embedded in the resin matrix and a layer of resin matrix being located at the inner surface.

In illustrative embodiments, the drum shell includes a unitary annular flange that is adapted to accept a tension ring to provide high tension on the struck side of the drum head and low tension on the snare side of the drum shell.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The present invention and the advantages thereof will become more apparent upon consideration of the following detailed description when taken in conjunction with the accompanying drawings of which:

FIG. 1 is a partial, cross-sectional view of the composite cylinder of the present invention;

FIGS. 2-4 illustrate a series of steps used in producing the composite cylinder of the present invention;

FIG. 5 is a perspective view of a completed composite cylinder produced by employing the steps illustrated in FIGS. 2-4

FIG. 6 is a perspective view of a drum fabricated using a composite drum shell showing a high tension drum head coupled to a flange ring using a series of tension lugs and a low tension drum head secured to the flange ring using a series of tension rods;

FIG. 7 is a side elevational view of the drum of FIG. 6 showing the high tension drum head coupled to the flange ring using a series of tension lugs and the low tension drum head coupled to the flange ring using a series of tension rods;

FIG. 8 is a top view of the drum of FIG. 6 showing the drum head;

FIG. 9 is a cross section of the drum taken along lines 9-9 of FIG. 7 showing the high tension drum head coupled to a flange ring by use of a hoop and a series of tension lugs, the flange ring positioned to lie near the annular flange that extends outwardly from the side wall of the drum shell, and also showing the low tension drum head and hoop coupled to the flange ring by use of a series of tension rods;

FIG. 10 is perspective view of the drum shell showing a smooth inner surface and an outer surface that includes the unitary annular flange;

FIG. 11 is a top view of the drum shell of FIG. 10;

FIG. 12 is a side elevational view of the drum shell;

FIG. 13 is an enlarged view of FIG. 12 showing the details of the annular flange of the drum shell;

FIG. 14 is a top view of the flange ring showing a tapered inner surface and a series of apertures positioned around the flange ring;

FIG. 15 is a cross sectional view of the flange ring taken along lines 15-15 of FIG. 14 showing the positions of the apertures;

FIG. 16 is an enlarged sectional view of FIG. 15 showing the angled face along the inner edge of the flange ring;

FIG. 17 is a top view of the inner hoop of the drum;

FIG. 18 is a side elevational view of the inner hoop;

FIG. 19 is a perspective view of another embodiment of the drum shell shown with a split flange and inner hoop;

FIG. 20 is a side elevational view of the drum shell;

FIG. 21 is an enlarged sectional view of the drum shell of FIG. 20 showing the flange positioned in the groove of the drum shell;

FIG. 22 is a partial sectional view of a cylindrical banjo rim on its side having a machined side wall adapted to accept a bronze tone ring;

FIG. 23 is a partial sectional view of a cylindrical banjo rim formed to include an integral tone ring;

FIG. 24 is a partial sectional view of a banjo showing the tone ring positioned on the banjo rim and also showing the banjo rim positioned on the resonator with the resonator being connected to the neck, the resonator is attached to the shell with a resonator flange, the neck is attached to the shell with a coordinator rod/rods; and

FIG. 25 is a cross section of the banjo rim, tone ring and resonator.

### DETAILED DESCRIPTION

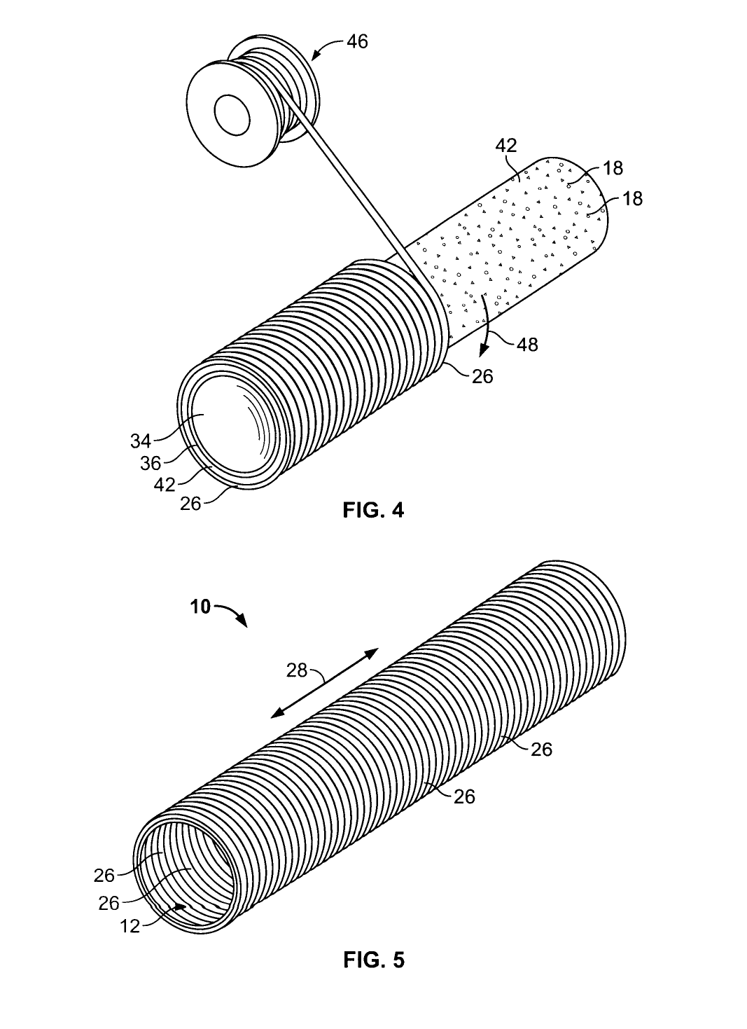

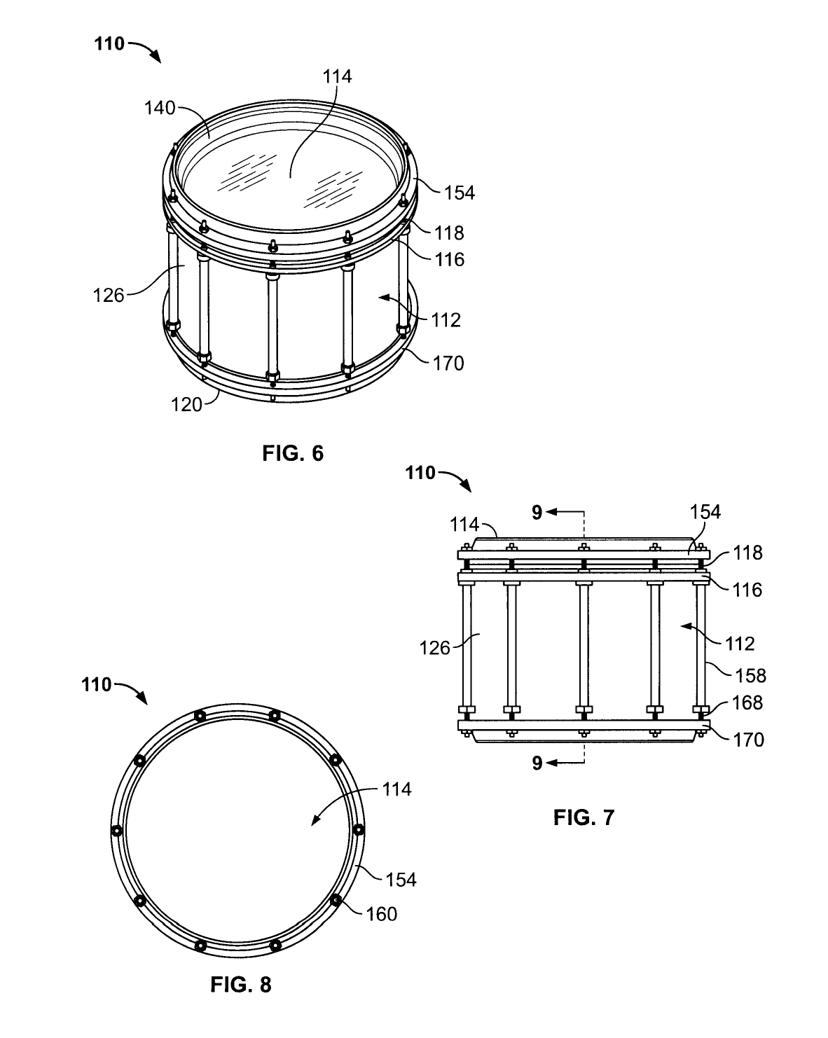

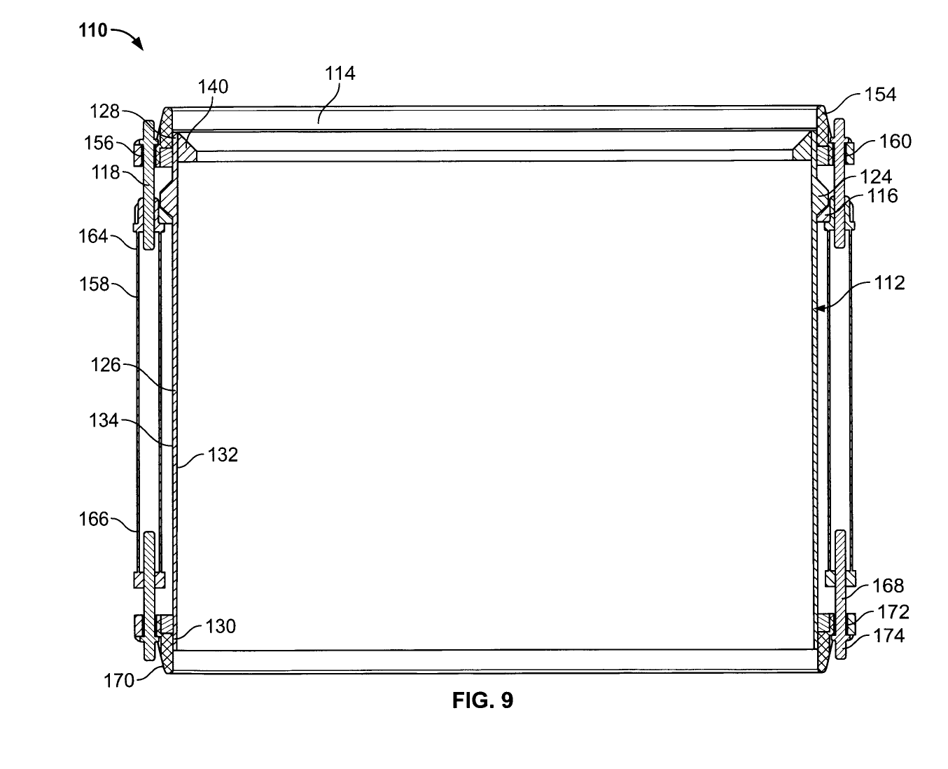

A drum 110 is shown having a composite drum shell 112 having a high tension drum head 114 and a low tension drum head 120 opposite the high tension drum head as shown, for example, in the perspective view of FIG. 6 and the cross sectional view of FIG. 9. High and low tension drum heads 114, 120 are coupled to drum shell 112 by use of hoops 154, 170, tension lugs 118, 168 and tube lugs 158.

Tension lugs 118 are coupled between an annular flange ring 116 and high tension drum head 114 to provide proper tension to hoop 154 to secure high tension drum head 114. Annular flange ring 116 is adapted to engage annular flange 124 of drum shell 112 to maintain its position.

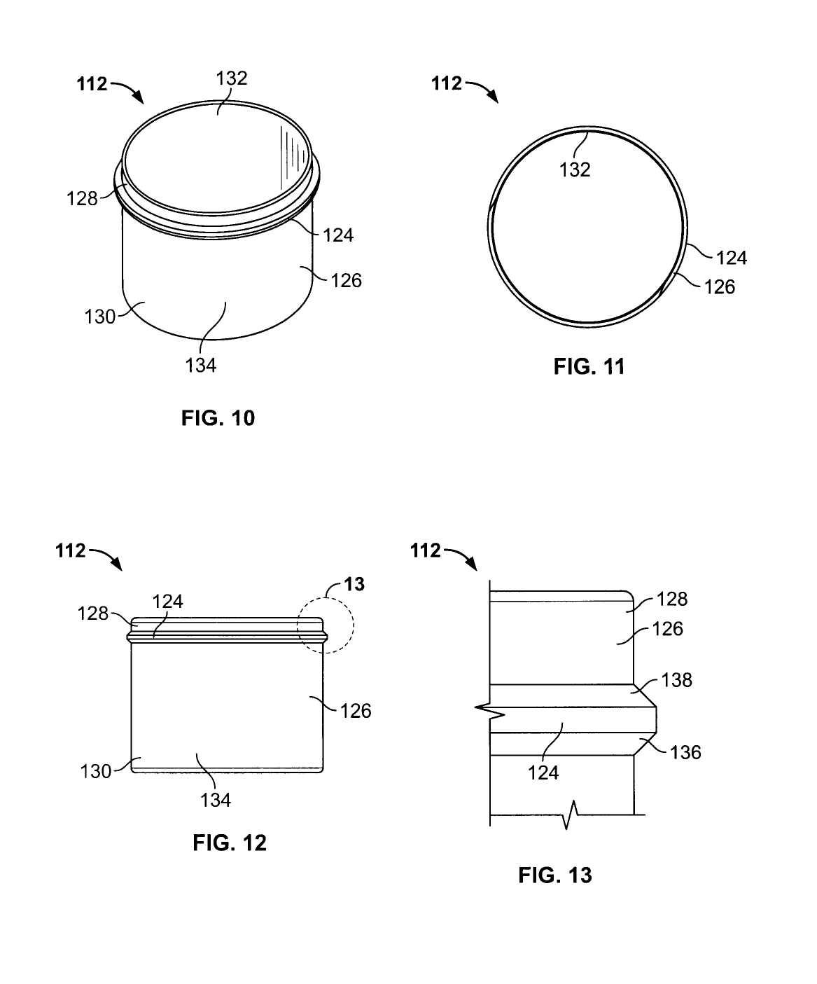

Composite drum shell 112 of drum 110 is shown in FIG. 10. Drum shell 114 is a one-piece composite cylinder of the type described herein. Drum shell 112 includes an annular side wall 126 having an upper edge 128 and an opposing lower edge 130. Drum shell 112 generally includes a resin matrix with a continuous filament material and, optionally, a plurality of particulate additives embedded therein as described below.

Side wall 126 of drum shell 112 includes an inside surface 132 and an outside surface 134, as shown, for example, in FIGS. 10 and 12. Inside surface is smooth and forms the inside of the drum. Outside surface 134 is preferably smooth and includes annular flange 124. Annular flange 124 is positioned to lie near upper edge 128 of drum shell 112 and can be machined into the drum shell 112. Alternatively, annular flange 124 can be glued to the drum shell so that drum shell 112 and annular flange 124 form a unitary structure.

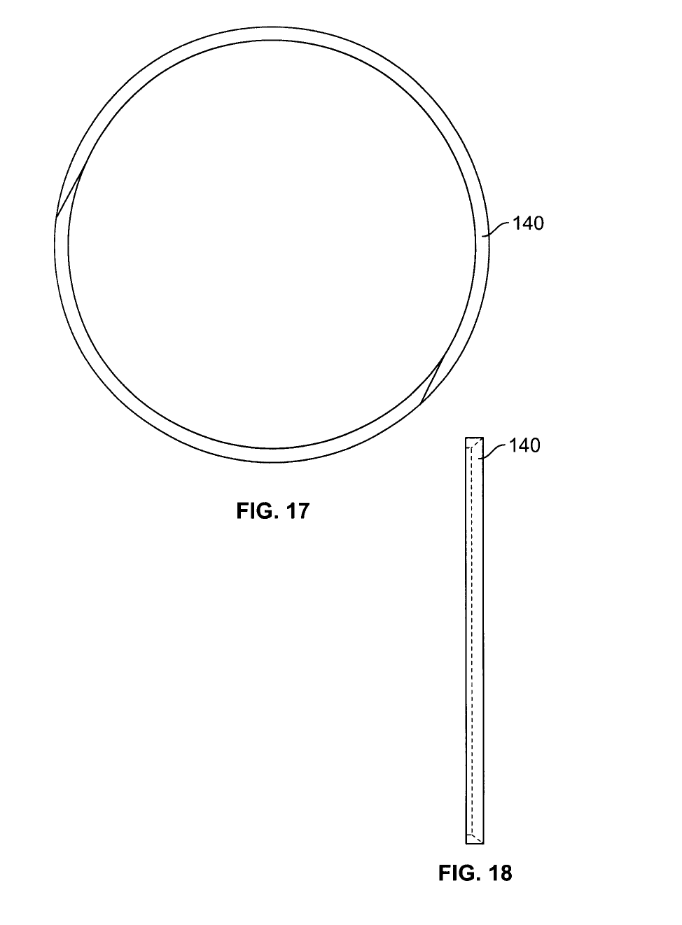

Annular flange 124 includes first and second beveled faces 136, 138, as shown in FIG. 13. First beveled face 136 is adapted to engage flange ring 116 when flange ring 116 is used to retain high tension drum head 114. Inside of drum shell 112 may also include an inner hoop 140, as shown in FIGS. 9 and 17. The inner hoop 140 is preferably made from the same material as the drum shell. Inner hoop 140 is a ring-type structure that is adapted to act as an internal stiffener to strengthen the upper edge 128 of drum shell 112. Inner hoop 140 is secured to inside surface 132 of drum shell 112 by use of an adhesive so that drum shell 112 and inner hoop 140 form a unitary structure.

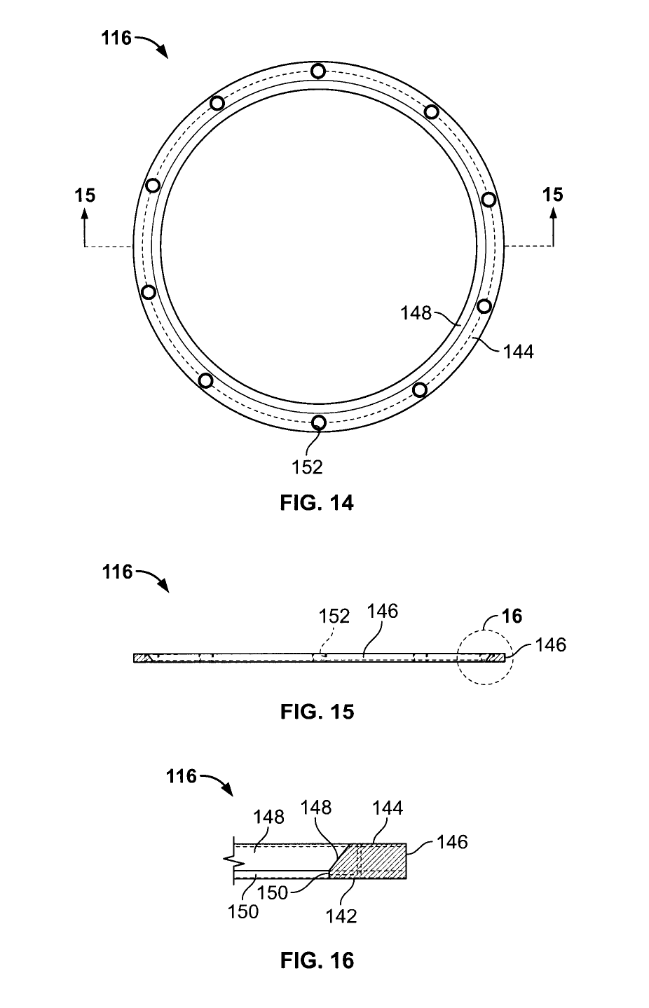

Flange ring 116 is positioned around drum shell 112 and is adapted to engage annular flange 124 as shown in FIGS. 14-16. The flange ring is preferably made from the same material as the drum shell. Flange ring 116 is used to secure the high tension drum head 114 to drum shell 112, as shown in FIG. 9. Flange ring 116 includes a bottom wall 142, a spaced apart top wall 144 and an outside wall 146. Flange ring 116 also includes a sloped inside wall 148 and a vertical inside wall 150. Sloped inside wall 148 as adapted to be positioned to lie near first beveled face 136 of annular flange 124 when drum 110 is assembled.

Flange ring 116 also includes a plurality of apertures 152 that are radially spaced about the flange ring and extend from the top wall 144 to the bottom wall 142. Apertures 152 are adapted to accept a plurality of tube lugs 158 used in combination with the tension lugs 118 to secure the high tension drum head 114 to the drum shell 112.

The high tension drum head 114 is designed to stretch over the opening of the drum shell 112, as shown, in FIG. 9. The high tension drum head 114 is stretched over and secured to drum shell 112 by use of an annular hoop 154. Hoop 154 fits over upper edge 128 of drum shell 114 and includes a plurality of openings 156 adapted to accept tension lugs 118. Tension lugs 118 extend from openings 156 in hoop 154 to tube lugs 158. Tube lugs 158 include an internal thread to allow tension lugs 118 to be threadably secured to tube lugs 158. Tube lugs 158 include an annular collar 160 to retain tube lugs 158 to flange ring 116.

Tension lugs 118 are secured to hoop 154 by use of fasteners 162 such as nuts. To increase tension on high tension drum head 114 fasteners 162 are tightened until the desired tension is reached.

Tube lugs 158 extend downwardly from flange ring 116 and are threaded at both ends for coupling to tension lugs 118, 168. Tube lugs 158 include a first end 164 that is coupled to tension lug 118 and a second end 166 that is coupled to lower tension lugs 168. Lower tension lugs 168 are used to secure lower hoop 170 to the lower edge 130 of drum shell 112.

Lower hoop 170 is adapted to stretch and secure low tension drum head 120 to lower edge 130 of drum shell 112. Lower hoop 170 includes a plurality of openings 172 that are adapted to accept lower tension lugs 168. Lower tension lugs 168 are coupled to lower hoop 170 by use of fasteners 174. Low tension drum head 120 is stretched over drum shell 112 by tightening fasteners 174.

The resultant drum 110 is designed to accommodate two separate drum head tensions, one for the top and one for the bottom. The drum shell 112 has a side wall thickness of approximately 0.085 inches and the weight reduction of the drum shell 112 over a standard wooden shell is approximately three pounds. The drum shell 112 is adapted to reduce the overall weight of marching drums to reduce fatigue on the carrier.

The upper rim or upper edge 128 is designed to withstand 40-50 inch pounds of torque on the tension lugs 118 resulting in approximately 25,000-30,000 pounds per square inch of tension with a Kevlar drum head. The lower rim or lower edge 130 is designed to withstand 5-10 inch pounds of torque on the lower tension lugs 168, which is a lower tension for the snare side.

The resultant drum 110 does not include any attachments to the drum shell 112 as the drum shell 112 is trapped between the high and low tension drum heads 114, 120. Manufacturing the drum shell 112 from the composite material greatly decreases temperature and humidity problems incurred with wooden drum shells, which can cause changes in tuning.

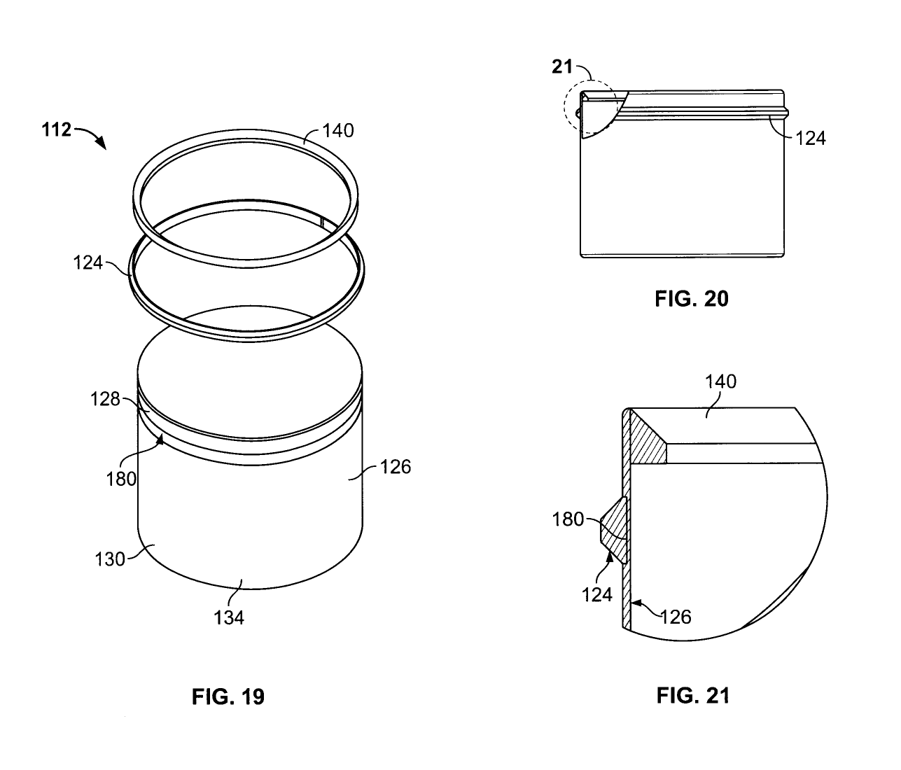

FIGS. 19-21 shown another embodiment of drum shell 112 that uses a groove 180, formed in side wall 126 of drum shell 112, to position split annular flange 124. Split annular flange 124 is secured into groove 180 by use of an adhesive. Also shown is annular hoop 140 positioned within upper edge 128 of inside surface 132 of drum shell 112. Hoop 140 is also secured to inside surface 132 of drum shell 112 by use of an adhesive. The resultant drum shell 112 is similar to the drum shell of FIG. 12 with the exception that the annular flange 124 is secured to drum shell 112 by an adhesive as opposed to forming the annular flange 124 during the machining/lathing of drum shell 112.

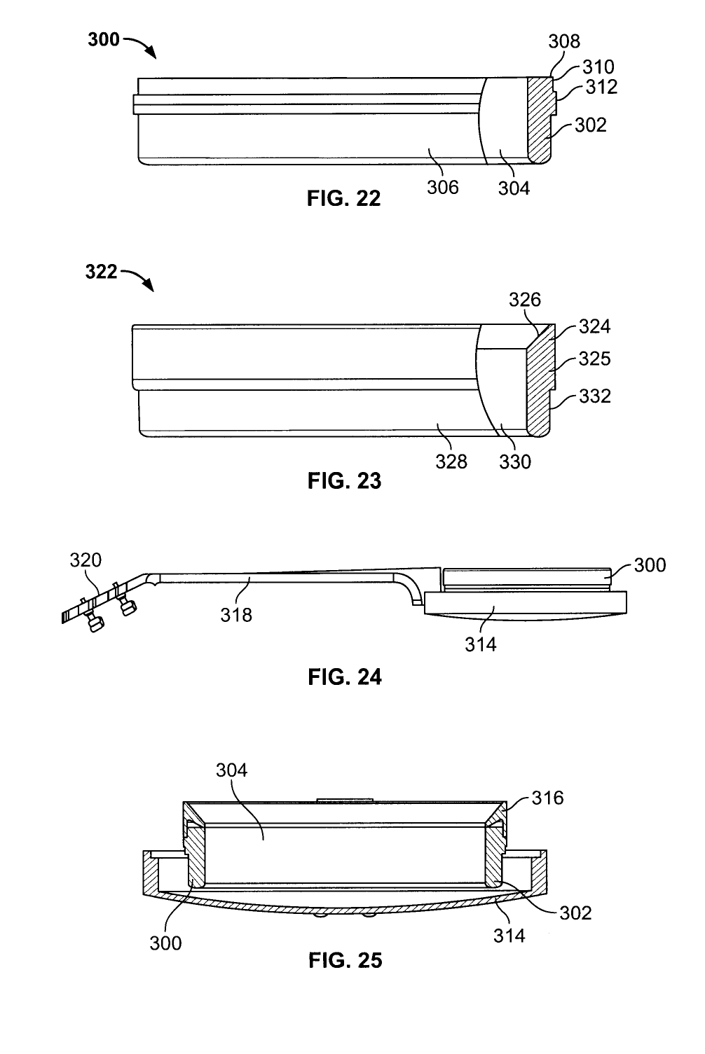

Composite cylinder 10 can also be used for manufacturing a banjo rim 300 used in the manufacture of a banjo, as shown in FIG. 22. Banjo rim 300 includes an annular side wall 302 having an inside surface 304 and an outside surface 306. Outside surface 306 is machined at upper end 308 to form an annular seat 310 adapted to accept a bronze tone ring 316 used in the construction of the banjo. Side wall 302 also includes an annular flange 312 positioned below annular seat 310. The banjo rim 300 is shown positioned within the resonator 314 with the tone ring 316 positioned on the banjo rim 300 in FIG. 24. The banjo also includes a neck 318 and head 320 coupled to neck 318. Not shown are the banjo head, strings, and bridge that connect the strings to head 320.

FIG. 23 shows a banjo rim 322 having a tone ring 324 that is integrated with the rim 322. Thus, the resultant rim 322 does not require a separate tone ring. The banjo rim 322 includes a side wall 325 having an inwardly sloping top surface 326 an exterior surface 328 and an interior surface 330. The exterior surface 328 is formed to include a recessed region 332 that is adapted to accept resonator 314. Banjo rims 300 and 322 are manufactured using the composite material as described herein.

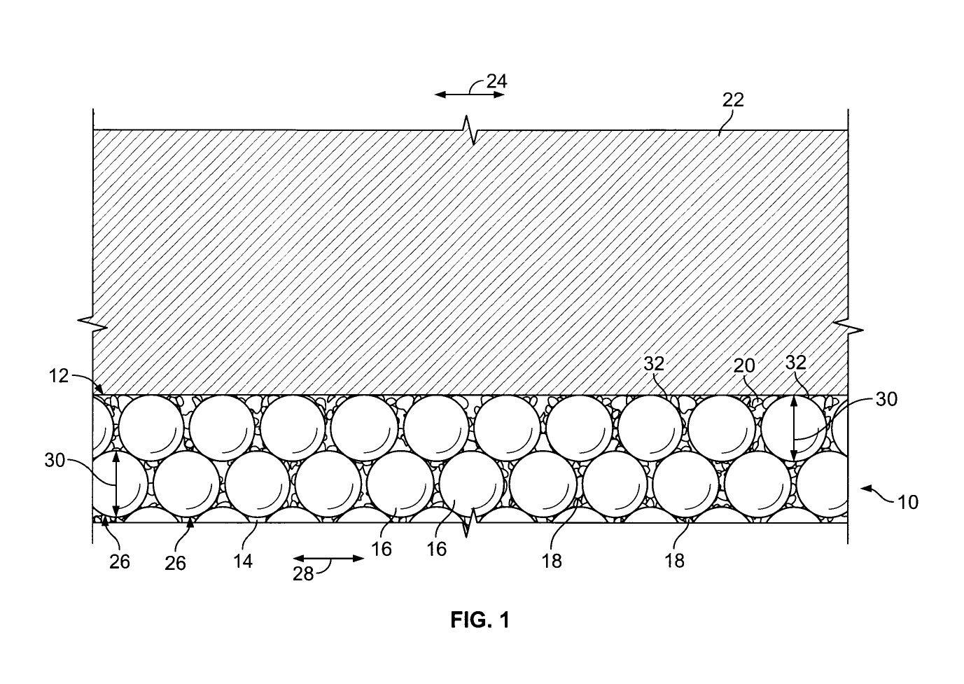

Referring now to the drawings, and more particularly to FIG. 1, there is shown an AeroSlide composite cylinder 10 having an inner surface 12. Composite cylinder 10 generally includes a resin matrix 14 with a continuous filament material 16 and, optionally, a plurality of particulate additives 18 embedded therein.

Resin matrix 14 is composed of a resin material having fumed silica (commonly sold under the trade name “Cab-O-Sil”) therein. Advantageously, 2% to 10% (by weight) thereof is employed with about 8% fumed silica being preferred. An inner layer 20 of resin matrix 14 exists at inner surface 12, thereby greatly, due to the hardness imparted thereto by the fumed silica present therein. The resin material may be made to be either translucent or colored, as desired. Translucence permits the composite cylinder 10 to be used with lights, while coloring possibly improves the aesthetic quality thereof.

Continuous filament material 16 is helically embedded within resin matrix 14 to thereby add to the toughness (i.e., durability) of composite cylinder 10.

Advantageously, filament windings 26 each have a round filament cross-section 28, thereby forming a series of rounded filament surfaces 32 at or near inner surface 12. Inner layer 20 of resin matrix 14 and the series of rounded filament surfaces 32 at or near inner surface 12 together actually define the totality of inner surface 12. In fact, the combination of the fumed silica in resin matrix 14 and rounded filament surfaces 32 permits the surface finish of inner surface 12 to be an arithmetic average roughness (Ra) of about 25 .mu.in or greater, whereas normal metallic or gel coated cylinders specify an Ra of less than 10 .mu.in.

Advantageously, continuous filament material 16 is a fiberglass material. Fiberglass offers advantages of good hardness, generally good durability, a round cross-section and translucency. Translucence can be desirable in a situation when it is desirable to illuminate the composite cylinder 10. Internal lighting devices could be incorporated to illuminate the drum shell 112. Also, internal sensing and triggering devices can be used to activate internal or external lighting or other devices. Conversely, fiberglass composite is a material that can be readily colored to a variety of different colors and shades, thereby permitting composite cylinder 10 to instead be colored, if desired.

Some possible choices for particulate additives 18 are polytetrafluoroethylene (PTFE), glass beads, fine ground silica, etc. or a combination thereof. PTFE, commonly sold under the trade mark “Teflon”. Glass beads each offer a rounded surface and good hardness. Fine ground silica helps increase hardness.

FIGS. 2-5 together illustrate various steps in the production of composite cylinder 10, including a perspective view of the finished product (FIG. 5). As set forth in FIG. 2, a highly polished mandrel 34 is provided to act as a mold for inner surface 12. Mandrel 34 advantageously has an arithmetic average roughness (Ra) of no more than about 10 .mu.in. To help achieve the desired level of roughness and promote easy release thereof from the finished product, mandrel 34 is chrome plated.

To further aid in the release thereof from the finished product, mandrel 34, as shown in FIG. 1, is desirably initially coated with a release agent 36 supplied by a release agent applicator 38 (shown schematically). Additives can be provided within release agent 36 that will adhere to inner surface 12. PTFE can, for example, be used as such an additive.

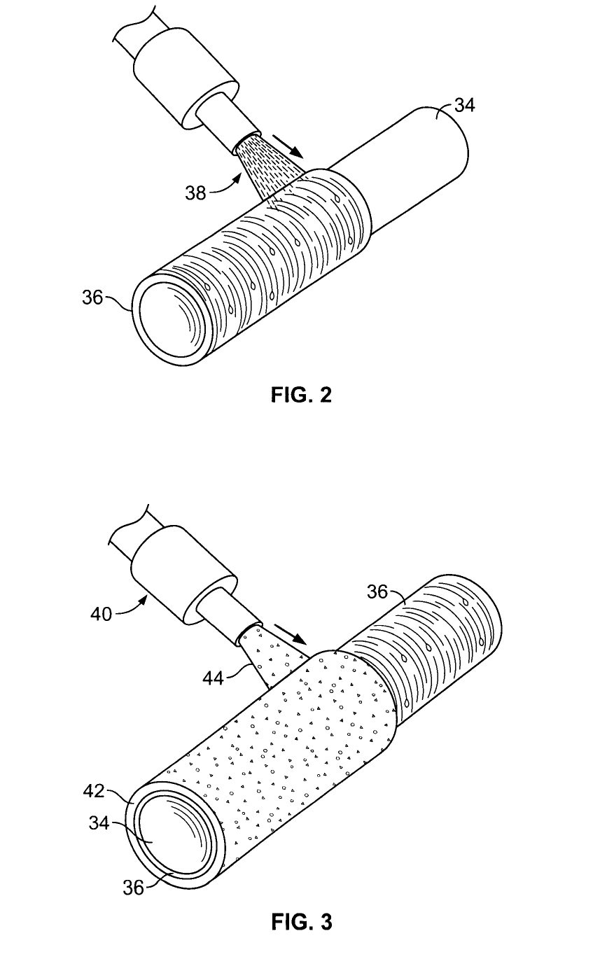

In FIG. 3, a resin source 40 of an appropriate resin material 42 and an associated resin applicator 44 are provided. Resin applicator 44 is advantageously a trowel applicator, permitting the application of a controlled, even thickness of resin material 42 on mandrel 34. Resin material 42 is applied, desirably in a form of a paste, upon mandrel 34. Resin material 42 is troweled substantially evenly over entire mandrel 34, preferably to a thickness of about ⅛ inch.

As illustrated in FIG. 4, a filament source 46 of continuous filament material 16 is supplied and via which filament windings 26 that are formed substantially transversely of primary direction 26. (Mandrel 34 could be rotatably driven, as schematically shown via arrow 48, to promote the winding of continuous filament material 16 thereon.) Filament windings 26 displace and otherwise become embedded in resin material 42 during this step. After a suitable number of filament windings 26 have been formed along the entire length of mandrel 34 in resin material 42, continuous filament material 16 is cut (not shown) and, desirably, excess resin material 42 is wiped (not shown) from the outside of now-formed composite cylinder 10 before resin material 42 has an opportunity to cure.

Once resin material 42 cures, mandrel 34 is then removed from composite cylinder 10 to reveal the finished product shown in FIG. 5.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A composite acoustic drum shell to which a drum head is to be attached, the composite drum shell comprising
an annular side wall formed of a composite material and having an upper end and a lower end,
an annular flange radially extending from an outer surface of the side wall and positioned near one of the ends.

2. The composite acoustic drum shell of claim 1, further including an annular flange ring positioned around the drum shell and adapted to engage the annular flange.

3. The composite acoustic drum shell of claim 2, wherein the annular flange includes a beveled face that is at an angle to the side wall of the drum shell.

4. The composite acoustic drum shell of claim 3, wherein the annular flange ring includes a sloped wall that is adapted to engage the beveled face of the annular flange.

5. The composite acoustic drum shell of claim 1, further including an inner hoop adapted positioned on an inside surface of the annular side wall near the upper end.

6. A composite acoustic drum comprising:
a drum shell having an annular side wall formed of a composite material and having an upper end and a lower end,
an annular flange extending outwardly from an outer surface of the side wall and positioned near one of the ends,
a first drum head positioned over the upper end of the drum shell,
a first hoop for securing the first drum head to the drum shell,
an annular flange ring positioned around the drum shell in engagement with the annular flange, and
means to couple the first hoop to the flange ring to secure the first hoop to the drum shell.

7. The composite acoustic drum of claim 6, wherein the annular flange includes a beveled face that is at an angle to the side wall of the drum shell.

8. The composite acoustic drum of claim 7, wherein the annular flange ring includes a sloped wall that is adapted to engage the beveled face of the annular flange.

9. The composite acoustic drum of claim 6, wherein the means to couple the first hoop to the flange ring includes a plurality of tension lugs.

10. The composite acoustic drum of claim 9, wherein the tension lugs are coupled to the flange ring by use of a series of tube lugs.

11. The composite acoustic drum of claim 10, further including a second drum head positioned over the lower end of the drum shell.

12. The composite acoustic drum of claim 11, wherein the second drum head is coupled to the flange ring by use of a hoop.

13. A composite acoustic drum shell to which a drum head is to be attached, the composite drum shell comprising
an annular side wall formed of a resin matrix composed of a resin material having fumed silica therein, the resin material at least partially at an inner surface of the side wall,
a substantially continuous filament material embedded within the resin matrix, the substantially continuous filament material including a round cross-section.

14. The composite acoustic drum shell of claim 13, wherein the resin matrix further contains a plurality of particulate additives, said particulate additives being at least one of polytetrafluoroethylene, glass beads and ground silica.

15. The composite acoustic drum shell of claim 14, wherein the resin comprises about 2% to 8% by weight of fumed silica.

16. The composite acoustic drum shell of claim 15, wherein the drum shell includes an annular flange formed on an outer surface of the side wall and positioned near one end of the drum shell.

17. The composite acoustic drum shell of claim 16, wherein the annular flange includes a beveled face that is at an angle to the side wall of the drum shell.

18. The composite acoustic drum shell of claim 17, further including an annular flange ring positioned around the drum shell and adapted to engage the annular flange.

19. The composite acoustic drum shell of claim 18, wherein the annular flange ring includes a sloped wall that is adapted to engage the beveled face of the annular flange.

20. A composite banjo rim for use in the manufacture of a banjo comprising
an annular side wall formed from a filament material embedded within a resin matrix.

21. The composite banjo rim of claim 20, wherein the resin matrix is composed of a resin material having fumed silica therein, the resin material at least partially at an inner surface of the side wall.
